(19) United States
(12) Patent Application Publication
(10) Pub. No.: US 2008/0088443 A1
(43) Pub. Date: Apr. 17, 2008

(54) SCANNING DEVICE WITH SENSORS AND CAMERA OR TRICORDER

(76) Inventor: MICHAEL FRANCIS NIEMI, Taylarsville, UT (US)

Correspondence Address: Michael Francis Niemi, 3855 West 5400 South PMB 128, TAYLORSVILLE, UT, 84118, US

(21) Appl. No.: 11/935,438

(22) Filed: Nov. 6, 2007

Related U.S. Application Data
(63) Continuation-in-part of application No. 10/621,013, filed on Jul. 17, 2003.

(51) Int. Cl. G08B 21/00

(52) U.S. Cl. 340/540

(57) ABSTRACT

An application to use of a robotic controller board to manage the influx of data from one or more sensors, and to send that data, in RS232 or serial form, to a Computing Device (see CLAIM VIII). In this case, the images attached are created from a Prototype built for a Palm Handspring Visor Prism PDA with an Eye Module 2 Camera to sense heat, motion, direction and distance from objects from the Scanning device. The Prism also has onboard Clock and Palm OS software that can be used, like Notepad, to take notes, and other built in applications for the user to store data about an incident(s) that the Scanner is recording or had recorded. The Application in its prototype form, and as shown, is short ranged and is meant to be used by a coordinated number of users to find changes hazardous to human life

This application is a continuation in part of Ser. No. 10/621,013 filed November 5 h, 2003.

The Handheld Scanner or Tricorder is a combination of devices assembled in a new way to provide users a handheld way to record threats or events detrimental to Human life. The basic structure is a computing device (see CLAIM VIII) as seen built in the prototype (see FIG. 1a) of that of a Palm OS PDA (in this case the Handspring Visor Prism running Palm OS 8.01 operating system) attached on top of a Sensor Pack that is fully independent in operation to the computing device, that can hold sensors (see FIG. 1b) in a separate case that detects in which the prototype can detect Radiation (see Geiger Muller Tube in FIG. 1d), Heat, UV, Smoke, movement, direction via electronic Compass or GPS device and can alert the user visually. It also allows the user to make use of third party Mapping software called StreetMaps, which has been loaded into the Prototype, and the ability to use the any of the other software built into shown Prism software to record photographs of the scene and take notes or other software present. The Application in its prototype form, and as shown, is short ranged and meant to be used by a coordinated number of users to find changes

The Sensor Pack is controlled by a BrainStem robotic controller that takes in data in from sensors attached to its main three (3) input ports (see FIG. 1c), it can accept raw data from any kind of sensor in Analog, Serial or IIC (I squared C) formats. The Programming (see FIG. 1d) of the Brainstem steps to each sensor in round robin fashion.

This patent application does not attempt to patent the Language inside the Acroname BrainStem Board, but the program I had written to take advantage of what is present on the Acroname BrainStem board. Combined with the low power sensors attached to each Pin set (positive and negative) either a character or electrical impulse is sent to activate, read and in some cases, have the unit shut down the sensor to save electricity from either a plain 9-volt battery or the 9.6 rechargeable battery as shown in FIG. 1a. The sensors researched for the patent and the ones put in use, use up to 5 mille volts of power and they can take 3 to 5 mille seconds to respond. For all four sensors in FIG. 1d to respond, the strobing of each set of pins takes in reality only less than a second. It is up to the user to request or add additional sensors (gas sniffers, infrared devices or other sensors), the program was written to access each set of all set of 12 pin sets every three seconds.

The Handheld Scanner shown in FIG. 1a is designed to operate both the PDA and Sensor Pack from a 9.6 rechargeable Lithium Ion Battery. The way the Prism is built, two wires can fool the Prism to think it's recharging because the PDA is attached to the Sensor Pack, the length of RS232 cable can be quite long. So the Sensor Pack can be fixed and powered by the rechargeable battery, a vehicle or buildings power supply. If the Sensor Pack is fixed and power is generated from an electrical outlet, the power limitations and number of sensors is irrelevant, the Sensor Pack can handle any kind of sensor and does not need to be carried by hand. The PDA can be mounted for the Users convenience and powered by a wall socket, vehicle wiring or by its internal rechargeable battery, making it more useful.

This gives the program the ability to hot connect sensors and gives the BrainStem to round robin or read each sensor individually and sent back its data where my program appends this data to a ASCII string, to send the Prism (or other computing device) shown all the data in one burst The memory on the BrainStem is sent to the Prism and is immediately cleared. Acroname has a kit for cameras that fit onto the BrainStem instead of using any camera that may by mounted on any other computing device or if any other computing device lacks a camera. This patent application includes in a general way, a camera to be a sensor if it has to be attached to the BrainStem.

The Prism program, that runs independently of the BrainStem program to collect and send data to the Prism, receives data from the Sensor Pack and processes it on the screen. The Sensor Pack does not have any kind of readable device on it. Its main purpose is to collect data, this makes placement of the Sensor Pack irrelevant to placement in or on the user. The Sensor Pack can be worn on a belt. The prototype shown here creates all devices into one package. Other Claims make use of the Sensor Pack to be fixed, or tied to a vehicle or a wall or other surface. The Attachment of the Sensor Pack is dependant of the signal strength of the RS232 cable, as shown in FIG. 1a.

If the PDA device can hold a camera, like the EyeModule2 on the Prism pictured in FIG. 1a. The PDA devotes a part of the screen to stream the video constantly. The Camera has a mechanical shutter and the PDA software has a software shutter, where pictures can be taken on the scene, or when another sensor sends a value, the program running on the Prism can evaluate it and decide to snap a picture automatically in the prototype scheme. If the user decides to swap a computing device that lacks a camera but wants a camera, added in another way, a camera kit exists for the Acroname BrainStem.

The BrainStem Language accepts commands into it as well. To get the same results, a sensor trigger reporting a high or low event can go from the BrainStem program, to the Prism Program. The Prism Program can tell the BrainStem program to use its camera to record the image and send it back in the next stream of data. This is not part of the prototype but it can be done. While MONROE and the PICO devices already can be configured this way, I withdrew this claim, but the camera is an instrumental part of any array of sensors, the potential use and the way it can be proven it will work in the prototype may preclude it in part, but not of the whole.

The Handheld Scanner Prototype is meant to be carried by users by hand. The limits of the sensors may be programmed to alert the User or to trigger other operation automatically. This patent application takes in sensors not available at the time of MONROE device (U.S. Pat. No. 6,518,881), which MONROE DEVICE makes no claims for a Nitrate Sensor released for use in 2005. MONROE has no teachings or it is not obvious how it will handle new devices.

Lastly, The claims will show how it can be used in detail. The User also has access to all normal in the shown Prism software, like the Palm OS Notepad, to take notes at the time of the event. Nor the use or exercise of the Prism internal clock and calendar, which can report or log date and time during an Event. The Visors' EyeModule2 Software uses a Time and Date stamp when it records a picture when one of the shutters are pressed, or activated by a software trigger. The Continuation in part shows flexibility of sum or the third party software as advantage, some of which may be precluded by MONROE or the PICO devices, but adds to, not subtracts from application and the Device usefulness.

The language inside the Application Six claims was rejected by the Examiner due to MONROE U.S. Pat. No. 6,518,881). This Continuation in part includes here, appended, what MONROE does not teach or it is not obvious in the MONROE DEVICE. The MONROE DEVICE is basically surrounds itself primarily with a Patrol Car or Police Stop, for instance, the use of a Credit Card swiper either on the PDA or on the Laptop to check the Drivers License. Most the claims are made around this premise. The Sensors are affixed in certain positions and are hard wired into the vehicles electrical system to get power. They are also had to be hardwired inside the same vehicle to send data. The many of the sensors need to be close to and/or in line of sight of an event or source of what they are capable to detect. None of my research makes sensors available that perceive or send that data in any other manner than wiring. That may change, but MONROE does not anticipate this. MONROE device makes no claim on new sensors, anticipates changes, or any obligation in performing its duties while operating in a vehicle.

MONROE uses a GIEGER COUNTER as a broad description of the Geiger Muller tubes out there. The Geiger Muller and other tubes that detect do detect broad-spectrum radiation subjected to open air. As articles appear about concealment and creation about dirty bombs arise, where a small amount of radioactive material is used in conjunction with a very high explosive, spreading the containment around by the explosion, but poisoning as many people around in reach of the bomb. The MONROE claims do not teach or it is not obvious how the MONROE device can detect a threat until a dirty bomb explodes, accidental spill of radioactive contrast used in medical buildings, and level of radioactive elements other such incidents must be high for the MONROE device to catch is neither taught nor is not obvious.

Saying this about sensor operation, What Monroe does not teach nor is not obvious, is that in my research of the sensors, MONROE uses higher powered sensors, but with the exception of a few, the position of the Vehicle may hinder or obstruct obtaining the data that MONROE claims. Nor does it teach nor is not obvious how a vehicle can reach or obtain data like heat, C02, or other outgases from inaccessible spaces like interior building rooms, halls, crawlspaces or ductwork. It can not fully use alerts of a singular sensors range (high or low) to trigger an automatic operation if the sensor is obstructed by the vehicle or the event is inaccessible to the vehicle by physical barriers, distance or obscured hazards, like water (pools, lakes, rivers), smoke and/or heat, that may be harmful to the vehicle and user themselves before the MONROE device can or maybe able to alert the user.

MONROE does not teach or it is not obvious how a car approaching a radioactive or burning building with a lake in front to the building which creates its own immediate weather.

It does not teach nor is not obvious how the MONROE device can send and receive data to and from the device nor control the PDA except through cellular communications As Hurricane Katrina as shown, Cellular towers can be destroyed or robbed of power. September 11^{th}, 2001 has shown us, Cellular traffic after a major attack can destroy or cause so much traffic on cellular towers that the Cellular traffic, so this is not obvious how the MONROE device can do this in such dramatic events.

The PDA that MONROE device has claimed does not teach nor is it obvious how the device can snap a picture, clear the PDAs memory in storing the picture. These functions, including using the PDA to use its on board camera, as claimed in MONROE, must be done by a user.

I: The device is claimed, properly powered and equipped with up to 36 sensors, can be used as a portable data recorder and to provide data as an on screen alert, and/or to be saved for analysis after some kind of event or threat has been averted or detected. MONROE does not teach portability in the sense of spaces where only a human can reach and a vehicle cannot. It is not obvious in MONROE that the intended use is other duties other than Police for traffic stops, the majority of the claims is in examination of a traffic stop. It is not obvious in MONROE how the device would detect heat, or any other substance in a crawlspace, rooftop or any space not accessible by vehicle, nor does it teach us any other expanded use. It is not obvious nor teaches how a PDA can collect air samples for the devices in the vehicle. The MONROE device and the PDA are separated and the MONROE device makes no claim in control of the PDA.

II: In relation to claim 1, The device can be used, with batteries and the proper sensors, as a personal documentation device in hazardous situations or other conditions, where the danger is masked somehow to the user. MONROE does not teach nor is it obvious how the vehicle itself when out of position or behind another obstacle or barrier where the hazard is not in line of sight with the sensor, how MONROE would detect a hazard that is out of sight or obscured.

III: In relation to claim 1, The device can use an Electronic Compass that can determine the location of the user. MONROE does not teach nor is it obvious how the device or sensors can be used if the operator of the vehicle is considerably away from the vehicle.

IV: In relation to claim 1, the device can record with the IR Ranger and a PDA Camera, can photograph any change in distance or movement by the program running continuously inside the CPU. In light of PICO and MONROE, claim IV is withdrawn.

IV: In relation to claim 1, The device, when properly outfitted with a camera (some PDA devices do not have internal cameras) and IR Ranger, and properly wired to a vehicles internal electrical system, can take pictures automatically of a vehicle too close; or judged by PDA programming of distance vs. speed, to be a hazard of imminent collision with the front and back of the so-equipped vehicle. MONROE makes no claim what so ever about how MONROE device can determine a collision or near collision from the Squad Car referred to in claims and another vehicle. MONROE does not make it obvious nor makes claim, nor uses a PICO device, so that the CPU detects that the vehicle is in any kind of jeopardy and give alert.

VI: In relation to claim 1, the device, when properly outfitted with the Heat Sensor and IR Ranger can visually warn a user inside or outside of a building of the dangers of a fire, or wall, obstruction, or dangerously heated object, when obscured by smoke. MONROE makes no mention of the vehicles orientation as per a wall or if the vehicle can be near an inner wall. Smoke makes occur outside a building but smoke is more of a hazard or nuisance inside a building. MONROE makes no claim how it would alert inside building conditions.

VII. In relation to claim 1 and as a new claim, the Sensor Pack can be equipped with several types of Geiger Mueller Tubes that in conjunction with a DC to DC adapter and 300 volt Capacitor to detect radiation. MONROE does not teach nor is it obvious which spectrum the Geiger Counter is constructed for.

VIII. In relation to claim 1, the Sensor Pack, part of the device with its own independent program, can give alerts to any kind of computing device, which includes and is not limited to PDAs, Cell Phones with embedded Operating systems, Laptops and Notebooks, Mini and Mainframe computers. MONROE maintains a single program and it is not obvious how the patent prevents the handheld Tricorder or Mainframe fixed Tricorder. Nor is it obvious how it gives users remote alerts outside from cellular phone signals where the vehicle is near a hazard and the user is not. Nor can it claim to alert the User via PDA or cellular phone when the user is about to stumble into a hazard that is not present near the vehicle.

IX. In relation to claim 1, the Sensor Pack with the Acroname BrainStem is in its own housing and has its own power source, which includes an outside cable for outside power and a cradle to hold (and charge) a 9.6 or a regular 9-volt battery. And that the BrainStem, programmed correctly, can read in 3 seconds each sensor, from 1 to 12 devices or sensors that send data Analog, Serial or IIC (I squared C) formats, which including sniffers that gauge the air for CO2, Nitrates, Ammonia, and other gases. When networked, multiple BrainStem boards can read from 13 to 36 sensors. The user has the total control of what the Tricorder is to be equipped for. MONROE makes no claims for addition of gas sniffers. Since all the sensors are connected to a single laptop, MONROE does not make it obvious how many sensors is capable of handling at one time. Laptops have an upward input limit, even if most sensors are USB.

X. In relation to claim 1, The Device can use Cameras and Microphones. The CPU program can capture and save sounds, or movies or photos, based on user request or automatically by alert limit from another sensor's upward or downward limit. MONROE does not teach how the device can do this in spaces where the vehicle cannot access.

XI. In relation to claim 1, The Device can power most handheld devices if they have the correct port, from the battery in the Sensor Pack, by fooling the handheld device it is being recharged while it is in use. Car lighter adapters use this trick for PDAs and Cell Pones. Neither the MONROE device shows it draws its power from a vehicle and does not teach nor it obvious how it would power all devices portable externally from the vehicle. The PDA referred to in MONROE device does not teach how the device controls the PDA remotely.

XII. In relation to claim 1, The Device pictured has infrared data output signal device and can talk or exchange data in case Cellular signals are not available. The MONROE device does not teach how the device nor makes it obvious how the device can contact anyone if Cellular signals are lost.

XIII. In relation to claim 1, The Device can be modified to network BrainStem boards together, giving the user access from 12 devices to up to 36 devices. The MONROE device does not teach how the device nor makes it obvious how the device can increase the number of sensors without extensive rewiring of the entire vehicle.
Attached are the figures and pictures as required by the Patents Office for the continuation in part of the application.
